(19) United States
(12) Patent Application Publication
(10) Pub. No.: US 2005/0086293 A1
(43) Pub. Date: Apr. 21, 2005

(54) Rating service for wireless device applications

(76) Inventor: David J. Buckley, Jamul, CA (US)

Correspondence Address: SAWYER LAW GROUP LLP, P.O. Box 51418, Palo Alto, CA, 94303, US

(21) Appl. No.: 10/687,055

(22) Filed: Oct. 15, 2003

(51) Int. Cl. G06F 15/16

(52) U.S. Cl. 709/203

(57) ABSTRACT

A method and system for submitting ratings for wireless device applications directly from a wireless device is disclosed. An option to submit a rating for a wireless device application is displayed on the wireless device. When a user selects this option, and the wireless device receives a rating, this rating is sent to a back-end server, along with a unique identifier for the wireless device and the application identifier. This rating is then stored in a database at the server. In this manner, ratings can be submitted directly from the wireless device. In addition, one rating for each wireless device application is stored for each wireless device. A user may submit multiple ratings for the same application on the wireless device, but only the most recent rating is stored.

### FIELD OF THE INVENTION

The present invention relates to wireless devices, and more particularly to applications on the wireless devices.

### BACKGROUND OF THE INVENTION

The ability of wireless devices, such as mobile phones and personal digital assistants (PDA), to run software applications is well known in the art. For example, users of wireless devices can purchase and play games on their devices. Some wireless network providers and software developers allow users of wireless devices to submit ratings for various wireless device applications through the Internet. The users can view how others have rated an application prior to purchasing the application, or at any other time.

However, a user is unable to submit a rating for a wireless device application directly from the wireless device. Instead, the user must log into the network provider's or the software developer's web site to submit the rating, thus requiring the user to have an Internet connection. In addition, users are not limited in the number of times they can submit ratings for a particular application. A user can submit multiple ratings for the same application, influencing the composite rating for the application. This prevents a true representation of user feedback on the application. In addition, users are not restricted in rating only applications that they own or have purchased.

Accordingly, there exists a need for a method and system for submitting ratings for wireless device applications directly from a wireless device. The method and system should also prevent multiple ratings from the same user for the same application and optionally restrict ratings to only the applications that the user has purchased. The present invention addresses such a need.

### SUMMARY OF THE INVENTION

A method and system for submitting ratings for wireless device applications directly from a wireless device is disclosed. An option to submit a rating for a wireless device application is displayed on the wireless device. When a user selects this option, and the wireless device receives a rating, this rating is sent to a back-end server, along with a unique identifier for the wireless device and the application identifier. This rating is then stored in a database at the server. In this manner, ratings can be submitted directly from the wireless device. In addition, one rating for each wireless device application is stored for each wireless device. A user may submit multiple ratings for the same application on the wireless device, but only the most recent rating is stored.

### BRIEF DESCRIPTION OF THE FIGURES

FIG. 1 illustrates a preferred embodiment of a system for submitting ratings for wireless device applications directly from a wireless device in accordance with the present invention.

FIG. 2 is a flowchart illustrating a preferred embodiment of a method for submitting ratings for wireless device applications directly from a wireless device in accordance with the present invention.

FIG. 3 is a flowchart illustrating in more detail the storing of the rating in the database at the server in accordance with the present invention.

### DETAILED DESCRIPTION

The present invention provides a method and system for submitting ratings for wireless device applications directly from a wireless device. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

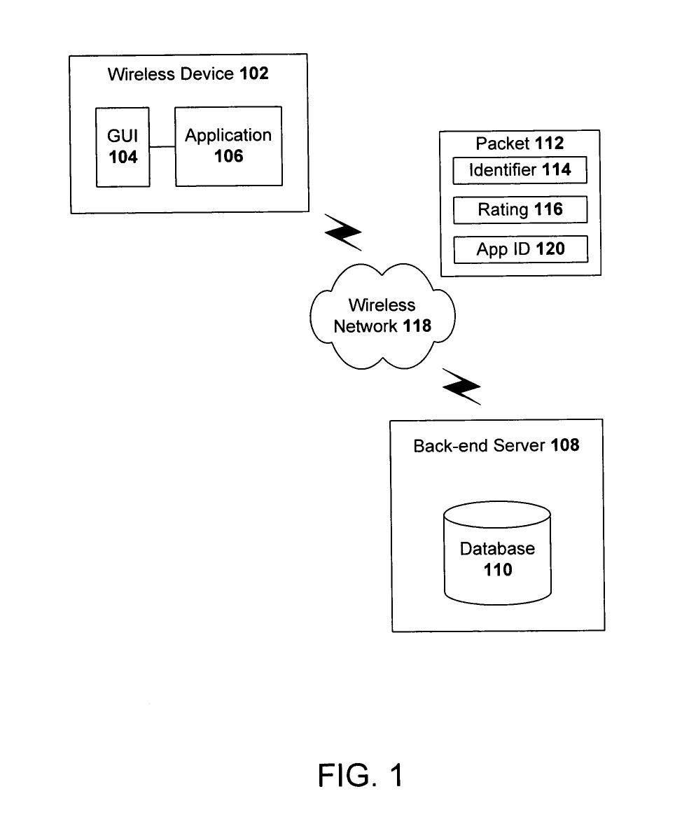

To more particularly describe the features of the present invention, please refer to FIGS. 1 through 3 in conjunction with the discussion below.

FIG. 1 illustrates a preferred embodiment of a system for submitting ratings for wireless device applications directly from a wireless device in accordance with the present invention. The system comprises a wireless device 102 and a back-end server 108. The wireless device 102 communicates with the server 108 via a wireless network 118. The wireless device 102 includes an application 106 and a graphic user interface (GUI) 104. The back-end server 108 includes a database 1 10 for storing ratings of wireless device applications.

The wireless device 102 can be a mobile phone, a personal digital assistance, or some other apparatus with wireless communication capabilities. The application 106 can be any that executes on the wireless device 102, such as games. The application 106 uses the GUI 104 to communicate with the user of the wireless device 102.

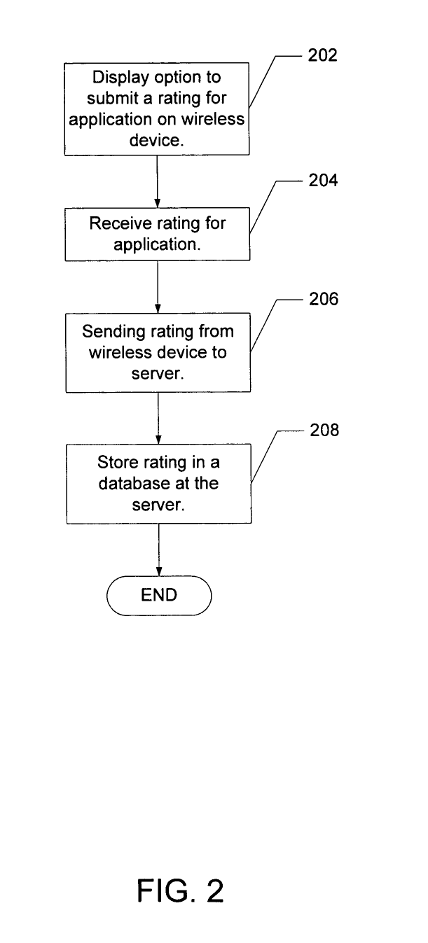

FIG. 2 is a flowchart illustrating a preferred embodiment of a method for submitting ratings for wireless device applications directly from a wireless device in accordance with the present invention. Referring to both FIGS. 1 and 2, first, an option to submit a rating for a wireless device application 106 is displayed using the GUI 104, via step 202. When the user selects this option, the wireless device 102 receives a rating for the application 106, via step 204. The rating is then sent from the wireless device 102 to the server 108, via step 206. In the preferred embodiment, a packet 112 is sent through the wireless network 118 that comprises a unique identifier 114 for the wireless device 102, the rating 116 for the application 106, and an identifier 120 for the application 106. Once the server 108 receives the packet 112, the rating 116 is stored in the database 110 at the server 108, via step 208. In the preferred embodiment, the unique identifier 114 and the application identifier 120 are stored along with its corresponding rating 116.

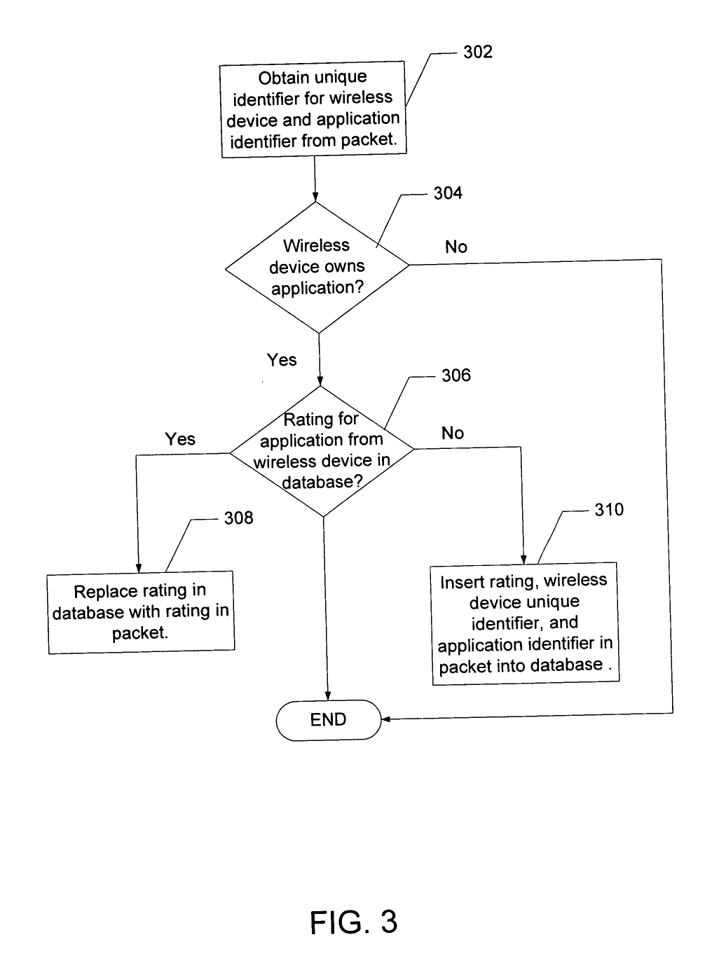

FIG. 3 is a flowchart illustrating in more detail the storing of the rating in the database at the server in accordance with the present invention. Once the server 108 receives the packet 112, the server 108 obtains the unique identifier 114 for the wireless device and the application identifier 120 from the packet 112, via step 302. Optionally, the server 108 can determine if the wireless device 102 owns the application 106 identified by the application identifier 120, via step 304. For example, the server 108 can access the wireless network provider's database (not shown) to confirm the wireless device's ownership of the application 106. Then the server 108 determines if the database 110 is storing a rating for the application 106 from the wireless device 106, via step 306. If so, then the rating currently stored in the database 110 is replaced by the rating 116 from the packet 112, via step 308. If not, then the rating 116 from the packet 112 is inserted into the database 110, along with the wireless device's unique identifier 114 and the application identifier 120, via step 310. In this manner, only one rating for each application is stored for each wireless device 102. A user can submit multiple ratings, but only the most recent rating is stored in the database 110. This prevents skewing of the composite rating for an application.

For example, assume that the wireless device 102 is a mobile phone, and the application 106 is a game. When a user plays the game 106 and reaches the end, a menu is displayed on the GUI 104, giving the user an option to submit a rating for the game 106 before the user exits the game 106, via step 202. Assume that the user selects the option to submit a rating. Then, a mobile web session is launched by the mobile phone 102. Alternatively, an Application Programming Interface (API) for communicating with the server 108 can be incorporated into the game 106 and used to send the rating to the server 108. If a mobile web session is launched, the user is taken out of the game 106 to submit the rating. The user would then have to re-launch the game 106 to reenter it. If the API is used, the user remains within the game 106 while submitting the rating. Afterwards, the user is returned to the game 106.

The user then enters the rating and gives the command to send, via step 204. In this example, the rating is in the form of one to five stars, but any type of rating can be used. Optionally, the user can enter free form text to be submitted as well. A packet 112 is then created which contains a unique identifier 114 for the mobile phone, the user's rating 116, a game application identifier 120, and the free form text, if entered by the user. In this example, the unique identifier 114 is the phone number for the mobile phone but can be any type of unique identifier. This packet 112 is then sent to the server 108, via step 206, through the wireless network 118.

Once the server 108 receives the packet 112, it obtains the mobile phone number 114 and the game application identifier 120 from the packet 112, via step 302. Optionally, the server 108 then confirms that the mobile phone 102 owns the game 106, via step 304. The server 108 then determines if the database 110 already stores a rating from the mobile phone 102 for the game 106, via step 306. If so, then the rating in the database 110 is replaced by the rating 116 from the packet 112, via step 308. If not, then the rating 116, the mobile phone number 114, and the game application identifier 120 are inserted into the database 110, via step 310.

With the present invention, the user can also be allowed to submit a rating via the Internet. The user would be required to log in through a web site using a unique identifier, such as a mobile phone number. As with the rating submitted directly from the wireless device, only one rating for each application is stored for each unique identifier. Confirmation that the wireless device owns the application can also be obtained before storage of the rating. Thus, the composite rating for an application still cannot be skewed.

Once ratings for a wireless device application have been received and stored in the database 110, a composite rating can be determined for the application. This composite rating is then accessible to a user through their wireless device or the Internet. For example, a user may view the composite rating prior to purchasing a wireless device application. Individual ratings and any free form text submitted along with a rating can also be accessible. In addition, recommendations for other wireless device application can be provided to a user based on the user's own ratings of the wireless device applications.

A method and system for submitting ratings for wireless device applications directly from a wireless device has been disclosed. An option to submit a rating for a wireless device application is displayed on the wireless device. When a user selects this option, and the wireless device receives a rating, this rating is sent to a back-end server, along with a unique identifier for the wireless device and the application identifier. This rating is then stored in a database at the server. In this manner, ratings can be submitted directly from the wireless device. In addition, one rating for each wireless device application is stored for each wireless device. A user may submit multiple ratings for the same application on the wireless device, but only the most recent rating is stored.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for submitting ratings for wireless device applications, comprising the steps of:
(a) receiving a rating for a wireless device application by a wireless device; and
(b) sending the rating from the wireless device to a server.

2. The method of claim 1, further comprising:
(c) storing the rating in a database at the server.

3. The method of claim 1, wherein prior to the receiving step, comprises:
(a1) displaying an option to submit the rating for the wireless device application.

4. The method of claim 1, wherein the sending step (b) comprises:
(b1) creating a packet comprising the rating, a unique identifier for the wireless device, and an application identifier for the wireless device application.

5. The method of claim 4, further comprising:
(b2) launching a mobile web session; and
(b3) sending the packet to the server.

6. The method of claim 4, further comprising:
(b2) sending the packet to the server utilizing an Application Programming Interface (API) within the wireless device application.

7. The method of claim 4, wherein the packet further comprises free form text received by the wireless device.

8. The method of claim 4, further comprising:
(c) receiving the packet by the server;
(d) determining if a database coupled to the server is storing a current rating for the wireless device application from the wireless device;
(e) replacing the current rating with the rating in the packet, if the database is storing the current rating; and
(f) inserting the rating, the unique identifier, and the application identifier from the packet into the database, if the database is not storing the current rating.

9. The method of claim 7, wherein the determining step (d) comprises:
(d1) determining that the wireless device owns the wireless device application.

10. A method for obtaining ratings for wireless device applications, comprising the steps of:
(a) receiving a packet from a wireless device, wherein the packet comprises a rating for a wireless device application;
(b) determining if a database is storing a current rating for the wireless device application from the wireless device;
(c) replacing the current rating with the rating in the packet, if the database is storing the current rating; and
(d) inserting the rating in the packet, a unique identifier for the wireless device, and an application identifier for the wireless device application into the database, if the database is not storing the current rating.

11. The method of claim 10, wherein the packet further comprises the unique identifier for the wireless device and the application identifier.

12. The method of claim 10, wherein the determining step (b) further comprises:
(b1) determining that the wireless device owns the wireless device application.

13. A method for submitting ratings for wireless device applications, comprising the steps of:
(a) receiving a rating for a wireless device application by a wireless device;
(b) creating a packet comprising the rating, a unique identifier for the wireless device, and an application identifier for the wireless device application;
(c) sending the packet to a server;
(d) determining if a database coupled to the server is storing a current rating for the wireless device application from the wireless device;
(e) replacing the current rating with the rating in the packet, if the database is storing the current rating; and
(f) inserting the rating, the unique identifier, and the application identifier from the packet into the database, if the database is not storing the current rating.

14. A method for submitting rating for wireless device application, comprising the steps of:
(a) receiving a rating for a wireless device application on a wireless device via an Internet web site;
(b) determining if a database is storing a current rating for the wireless device application from the wireless device;
(c) replacing the current rating with the received rating, if the database is storing the current rating; and
(d) inserting the received rating, a unique identifier for the wireless device, and an application identifier for the wireless device application into the database, if the database is not storing the current rating.

15. A computer readable medium with program instructions for submitting ratings for wireless device applications, comprising the instructions for:
(a) receiving a rating for a wireless device application by a wireless device; and
(b) sending the rating from the wireless device to a server.

16. The medium of claim 15, further comprising the instructions for:
(c) storing the rating in a database at the server.

17. The medium of claim 15, wherein prior to the receiving instruction, comprises the instructions for:
(a1) displaying an option to submit the rating for the wireless device application.

18. The medium of claim 15, wherein the sending instruction (b) comprises the instructions for:
(b1) creating a packet comprising the rating, a unique identifier for the wireless device, and an application identifier for the wireless device application.

19. The medium of claim 18, further comprising the instructions for:
(b2) launching a mobile web session; and
(b3) sending the packet to the server.

20. The medium of claim 18, further comprising the instructions for:
(b2) sending the packet to the server utilizing an Application Programming Interface (API) within the wireless device application.

21. The medium of claim 18, wherein the packet further comprises free form text received by the wireless device.

22. The medium of claim 18, further comprising the instructions for:
(c) receiving the packet by the server;
(d) determining if a database coupled to the server is storing a current rating for the wireless device application from the wireless device;
(e) replacing the current rating with the rating in the packet, if the database is storing the current rating; and
(f) inserting the rating, the unique identifier, and the application identifier from the packet into the database, if the database is not storing the current rating.

23. The medium of claim 22, wherein the determining instruction (d) comprises the instructions for:
(d1) determining that the wireless device owns the wireless device application.

24. A computer readable medium with program instructions for obtaining ratings for wireless device applications, comprising the instructions for:
(a) receiving a packet from a wireless device, wherein the packet comprises a rating for a wireless device application;
(b) determining if a database is storing a current rating for the wireless device application from the wireless device;
(c) replacing the current rating with the rating in the packet, if the database is storing the current rating; and
(d) inserting the rating in the packet, a unique identifier for the wireless device, and an application identifier for the wireless device application into the database, if the database is not storing the current rating.

25. The medium of claim 24, wherein the packet further comprises the unique identifier for the wireless device and the application identifier.

26. The medium of claim 24, wherein the determining instruction (b) further comprises the instructions for:
(b1) determining that the wireless device owns the wireless device application.

27. A computer readable medium with program instructions for submitting ratings for wireless device applications, comprising the instructions for:
(a) receiving a rating for a wireless device application by a wireless device;
(b) creating a packet comprising the rating, a unique identifier for the wireless device, and an application identifier for the wireless device application;
(c) sending the packet to a server;
(d) determining if a database coupled to the server is storing a current rating for the wireless device application from the wireless device;
(e) replacing the current rating with the rating in the packet, if the database is storing the current rating; and
(f) inserting the rating, the unique identifier, and the application identifier from the packet into the database, if the database is not storing the current rating.

28. A computer readable medium with program instructions for submitting rating for wireless device application, comprising the instructions for:
(a) receiving a rating for a wireless device application on a wireless device via an Internet web site;
(b) determining if a database is storing a current rating for the wireless device application from the wireless device;
(c) replacing the current rating with the received rating, if the database is storing the current rating; and
(d) inserting the received rating, a unique identifier for the wireless device, and an application identifier for the wireless device application into the database, if the database is not storing the current rating.
